(19) United States
(12) Patent Application Publication
(10) Pub. No.: US 2026/0319267 A1
(43) Pub. Date: Oct. 15, 2026

(54) ACETATE ENCLOSURE FOR EYEWEAR INCLUDING ELECTRONIC COMPONENTS

(71) Applicant: Sesame AI, Inc., Los Angeles, CA (US)

(72) Inventors: David Kalinowski, San Francisco, CA (US); Peter Nikiforov, Vancouver, WA (US); Luke Jones, Vancouver, WA (US)

(21) Appl. No.: 19/175,232

(22) Filed: Apr. 10, 2025

(51) Int. Cl. G02C 5/00; B29C 65/08; G02C 5/02

(52) U.S. Cl. CPC G02C 5/008; B29C 65/08; G02C 5/02

(57) ABSTRACT

An acetate eyewear incorporating electronic components is disclosed. The eyewear includes at least two portions, both comprised of acetate. The first portion is milled to incorporate a mating lip, rectangular in cross-section having a first and a second side and a face. The second portion comprised of acetate, the second portion milled to incorporate a counterpart stepwise mating structure, the counterpart stepwise mating structure having an upper step and a lower step, joined by a step riser, the lower step and the step riser. The pieces are joined together using ultrasonic welding when the second portion lower step matches the depth of the face of the mating lip and the step riser abuts the first face of the mating lip when the first portion and the second portion are placed together.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to eyewear and more particularly to acetate eyewear incorporating a cavity for housing electronic components.

### Description of the Related Art

Acetate has been a preferred material for eyewear since at least the 1960s. It was invented in the late 1800s, when it was created from plant fibers. It is typically derived from cotton or wood pulp, but other plant materials may be used. It is strongly preferred for eyewear because it is very durable, aesthetically pleasant, smooth to the touch (when polished), light-reflecting (i.e. luster) resistant to staining (e.g. perspiration), cellulosic (e.g. joined together in a cellular structure which makes it fairly uniform), hypoallergenic, heat dissipating, easily dyed (either while being created as a part of the structure or accepting dyes afterward) and retains the dye through virtually any interaction except completely melting.

Injection or shape-molded plastic is sometimes used in place of acetate because it may be manufactured more cheaply and quickly, and wire frames may be set within the plastics while they are being molded. These types of plastics, however, are more brittle, less light-reflecting, more prone to melting and discoloration, and generally are less durable than acetates. And, for all of these reasons and more, these types of plastics are generally less aesthetically pleasing than acetates and manufacturers and consumers of high-quality eyewear strongly favor acetates to other plastic options.

Despite these drawbacks, injection molded plastics have been used almost exclusively in the context of so-called “smart” glasses and other, similar wearables. The reason being that very thin acetates'structures are not easily glued together. And, to maintain their desirable characteristics, particularly their typical durability, acetates cannot easily be created in a “hollow” form and have been generally thought to be incapable of manufacturing in such a way to allow two thin pieces to be joined together to form a hollow cavity. The hollow cavity here being necessary to house electronics for the “smart” aspect of the smart glasses. When acetates are cut or milled thinly, then their structure breaks down and they become quite brittle and weak.

Likewise, no one has yet discovered how to join acetate structures on as small a scale as hollow eyeglasses need be without causing the acetates to basically melt. The typical process is to apply a solvent that breaks down the acetate, causing two pieces near one another to simply weld together after they have melted and rehardened. This process is similar to the more commonly-known process of “welding” PVC piping which relies upon application of a solvent which melts the exterior of two, nearby pieces of acetate, then rehardens after a few minutes or hours into effectively a single piece. In the context of hollow cavities involving sensitive electronic components, the prospect of liquid solvents and melted acetate interacting with batteries, microprocessors, cameras, and the like introduces too much variability. The likelihood that the solvent-based “welding” process damages critical components is high. In addition, the resulting welds are generally quite rough, basically being flowed, liquid acetate material. So, the process of polishing and finishing such joins for wear on one's face is likely to weaken the bond and introduce imperfections. In short, it is very undesirable for mass manufacturing in conjunction with sensitive electronics. Ultrasonic welding has generally been thought unsuitable for acetates, or at least on such a small scale as is present within the hollows of a smart pair of eyewear. In particular, the ability to ensure good joins between two or more acetate parts has been limited, and the acetate itself has been difficult to fashion into sufficiently thin, yet strong, subcomponents for use in an eventual combination.

As a result, all “smart” eyewear on the market today generally relies upon at least two counterpart portions of a frame (e.g. a left and right of an eyeglass frame) which are separately injection molded, one or both of into which electronic components are inserted or mounted thereon, with the counterpart piece then being glued in place and/or joined using pre-designed attachment points (e.g. snaps, rivets, etc.). These injection molded pieces are then combined into more “plasticky-looking” eyewear that appears less-serious, less-high-end, less-sophisticated, and less desirable for some more fashion-conscious consumers and less aesthetically pleasing.

### DESCRIPTION OF THE DRAWINGS

FIG. 1 shows a first block of acetate being cut into a front piece of front frame of a pair of eyeglasses.

FIG. 2 shows a second block of acetate being cut into a back piece of a front frame of a pair of eyeglasses.

FIG. 3 shows a mating lip along with components being added to the back piece.

FIG. 4 shows a stepwise mating structure of the front piece.

FIG. 5 shows the front piece and the back piece of the front frame of a pair of eyeglasses being joined.

FIG. 6 shows the front piece and the back piece of the front frame of a pair of eyeglasses being welded using an ultrasonic welder.

FIG. 7 shows the completed front frame of a pair of eyeglasses, including excess material.

FIG. 8 shows the completed front frame of a pair of eyeglasses, with excess material removed.

FIG. 9 shows an example cross-section of a mating lip and a stepwise mating structure of two pieces of acetate prior to ultrasonic welding.

FIG. 10 shows an example cross-section of a mating lip and a stepwise mating structure of two pieces of acetate following ultrasonic welding.

FIG. 11 shows an outer piece of a left earpiece of a pair of eyeglasses being cut from a block of acetate.

FIG. 12 shows an outer piece of a left earpiece of a pair of eyeglasses cut from a block of acetate.

FIG. 13 shows the back of outer piece of a left earpiece of a pair of eyeglasses including a stepwise mating structure.

FIG. 14 shows an outer piece and inner piece of a left earpiece for a pair of eyeglasses cut from acetate being joined together with electronic components therein.

FIG. 15 shows an outer piece and inner piece of a right earpiece for a pair of eyeglasses cut from acetate being joined together with electronic components therein.

FIG. 16 shows a completed pair of eyeglasses including a left earpiece, a right earpiece, and a front frame having excess material on the left and right earpieces.

FIG. 17 shows a completed pair of eyeglasses including a left earpiece, a right earpiece, and a front frame with all excess material removed.

FIG. 18 is a flowchart of a process for creating an acetate enclosure for eyewear including electronic components.

Throughout this description, elements appearing in figures are assigned three-digit or four-digit reference designators, where the most significant digits are the figure number, and the two least significant digits are specific to the element. An element that is not described in conjunction with a figure may be presumed to have the same characteristics and function as a previously-described element having the same reference designator.

### DETAILED DESCRIPTION

The inventor here has discovered that through the selection of a particular arrangement of mating structures and the application of a particular configuration of parameters for ultrasonic welding, that two carefully-milled pieces of acetate may be joined together into an aesthetically-pleasing, strong, and durable eyewear. Reliant upon the careful design of mating structures and precise calibration of the ultrasonic weld, the resulting weld is quite uniform and structurally sound. There is little to no excess material runoff from the weld and, any that does, runs to the exterior of the eyewear where it may be polished or otherwise finished away. The resulting eyewear is made of acetate, incorporates electronic components that are not likely to be damaged by the welding process, and are unharmed by an acetate material melted as a part of the ultrasonic weld.

As a result, the eyewear appears largely as an ordinary piece of high-quality, acetate eyewear, but may incorporate electronic components hidden within a hollow cavity between the two welded pieces. The particular mating structure is disclosed in the following description and accompanying figures along with the process and preferred parameters for performing a suitable ultrasonic weld.

### Description of Apparatus

Referring now to FIG. 1, a first block 100 of acetate being cut into a front piece 110 of front frame of a pair of eyeglasses is shown. Two independent blocks are used for the front and back pieces of a front frame (See FIGS. 1 & 2). Here, the first block 100 is cut using a milling process, a computer numerical control (CNC) cutting or milling process, computer-controlled water jets, or other, precise acetate cutting process. A rough out of the front piece 110 is created using a selected milling process. As will be see more clearly in figures to follow, the rough out of the front piece 110 is intentionally quite thick relative to an eventual piece of eyewear. This allows the two pieces to be more-easily joined and manipulated because the acetate retains its strength and durability during most of the remainder of the manufacturing process and through insertion of the electronics within the hollow cavities between the two pieces. The mating structure (not shown) may also be added at this stage of the milling process.

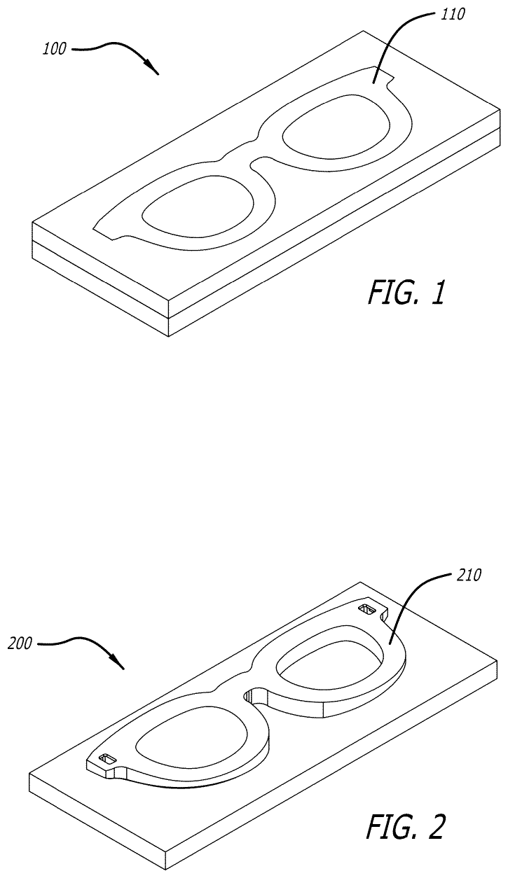

FIG. 2 shows a second block 200 of acetate being cut into a back piece 210 of a front frame of a pair of eyeglasses. Here, the back piece 210 is cut from a block of acetate. Again, this is a rough out of the eventual back piece 210. It may incorporate cutouts for insertion of additional pieces, like hinge components, and may begin or immediately incorporate the mating structures (not shown) eventually used to join the front piece 110 (FIG. 1) and back piece 210.

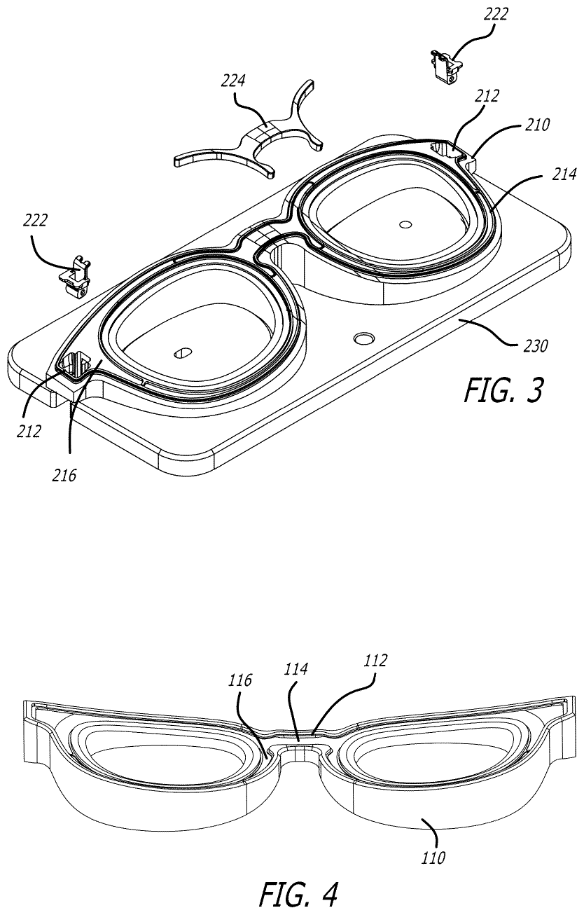

FIG. 3 shows a mating lip 214 along with components 222, 224 being added to the back piece 210. A hollow cavity 216 is formed within the interior of the mating lip 214. Although shown as the back piece 210 having the mating lip 214, the front piece 110 (FIG. 1) may instead have the mating lip 214 with the back piece 210 having a counterpart mating structure discussed below with reference to FIG. 4. The mating lip 214 runs along a near-perimeter of the face of the back piece 210. A near-perimeter, as used herein, means an area that would be just inside of a circumference if the shape were a circle. But, as the shape of the back piece 210 is irregular, the near-perimeter is a line along the exterior edge of a face of the back piece 210 (or any piece) along its periphery that is just inside of the perimeter.

A manufacturing block 230 may hold the front piece 210 in place while hinge studs 222 and a structural nosepiece 224 is added to the hollow cavity 216. The manufacturing block 230 enables precise, computer-controlled installation of components at desired locations, along with the use of precise amounts of adhesive (if desired) to hold components in place.

Electronics may also be added to the back piece 210 at this stage, within the hollow cavity 216. And, though discussed as a hollow cavity 216, the hollow cavity is only formed once the back piece 210 and front piece 110 (FIG. 1) are joined together. Here, the hollow cavity 216 means the space within in the interior of the mating lip 214 where the components 222, 224 are being added. Cameras, batteries, processors, lights, tiny displays, and the like may be added to the back piece 210 at this stage. The components 222, 224 may be inserted into pre-milled cavities 212 designed for their installation.

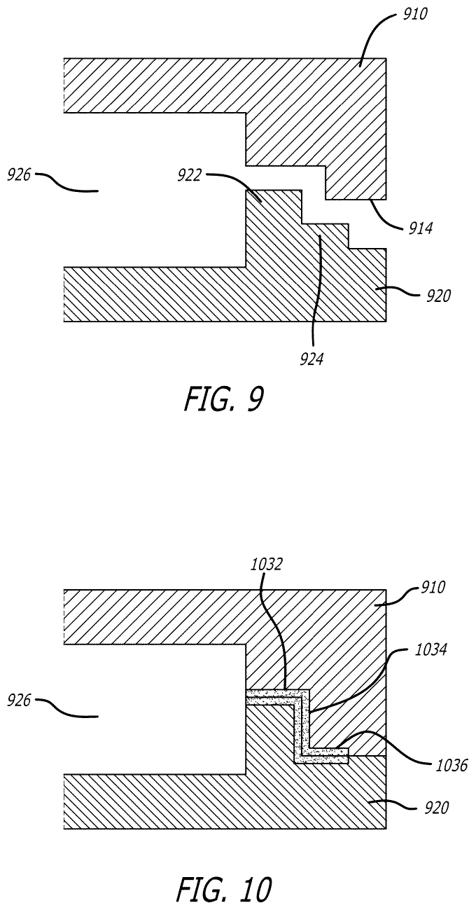

FIG. 4 shows a stepwise mating structure of the front piece 110. The stepwise mating structure has an upper step 112 and a lower step 114 such that it forms two “steps” for joining with the mating lip 214 (FIG. 3) through the application of the ultrasonic welding. As with the mating lip 214, the upper step 112 and lower step 114 are along a near-perimeter of the front piece 110. When combined with the back piece, the mating lip 214 (FIG. 3) rests atop the lower step 114, while the upper step 112 contacts the area immediately adjacent to the mating lip 214. A step riser may join the lower and upper steps, 114, 112. A hollow cavity 116 is formed therewithin. And, when ultrasonic welding is applied in precise parameters to this mating structure (formed of the stepwise mating structure including the upper step 112 and lower step 114 and the mating lip 214), the acetate melts very uniformly, with any residual acetate flows away from the hollow cavity 116. This will be discussed in more detail with reference to FIG. 9. But the flow of any acetate away from the hollow cavity 116 ensures that sensitive electronics housed therewithin are not damaged during the ultrasonic welding process.

This precise mating structure has been found to enable a particularly strong bond between acetate halves of eyewear (or other wearable devices) which require hollow cavities in which to place electronic components for “smart” functions. In particular, this mating structure properly focuses the ultrasonic waves on melding the two pieces (or halves) together without melting or negatively impacting the structural integrity of the overall acetate structure. Ultrasonic welding is preferrable because it avoids the flows of liquids described in the background section and avoids heat present in other types of welding. The weld is focused at the places where the mating lip 214 and upper and lower steps 114, 112 meet.

In addition, the resulting weld between the two pieces appears virtually or actually seamless. Because material flows into the seam “down” the stepwise mating structure and toward the exterior of the welded pieces, if there is excess it flows to cover any gap between the two pieces. And, to the extent it does not fully cover the gap, the two pieces are initially milled in a rough form that will be further milled down into a final form. So, the welded material flow, once solidified after a weld, fills the potential seam between the two pieces sufficiently that when the rough form is milled down to a final form, any gap or seam entirely disappears. In its place is the welded material that was melted/flowed through the seam and appears to be a single piece. The resulting appearance is quite striking as it appears to be a single, solid piece of acetate, with no seam at all, that may then house components, including electronic components, therewithin. To those unfamiliar with the ultrasonic welding process described herein, it feels as though the acetate material was formed of a single piece with the electronics placed within the acetate while it was solidifying.

Other, similar mating structures are possible. For example, a plurality of steps more than two may be used along with a corresponding number of mating lips, each at an appropriate height for each step. The locations of a given set of steps and mating lips maybe swapped to either piece without altering their function. A series of curved protrusions, approximating steps and a counterpart mating lip, may be used instead. A plurality of portions of a mating lip and corresponding portions of a stepwise mating structure may be used, with each of those portions taking up only part of a near-perimeter of the associated piece. In such cases, a plurality of independent welds may meet at those portions, but not be present in other parts of the two pieces being combined.

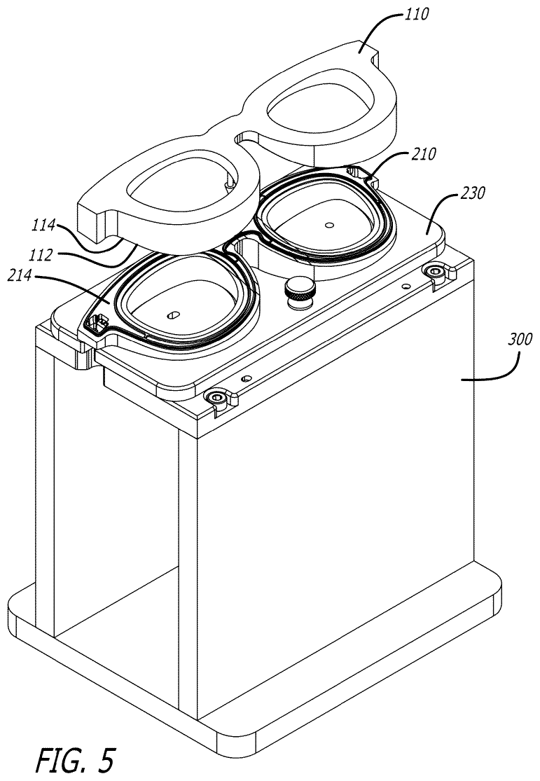

FIG. 5 shows the front piece 110 and the back piece 210 of the front frame of a pair of eyeglasses being joined. The manufacturing block 230 is held atop a working stand 300. This configuration is shown to demonstrate that the process may be automated, with many hundreds of these manufacturing blocks 230 and working stands 300 operating in a conveyor-belt style manufacturing system to create many such eyeglasses in an automated or semi-automated fashion. Here, the upper step 112 and lower step 114 of the stepwise mating structure are being joined to the mating lip 214 prior to ultrasonic welding.

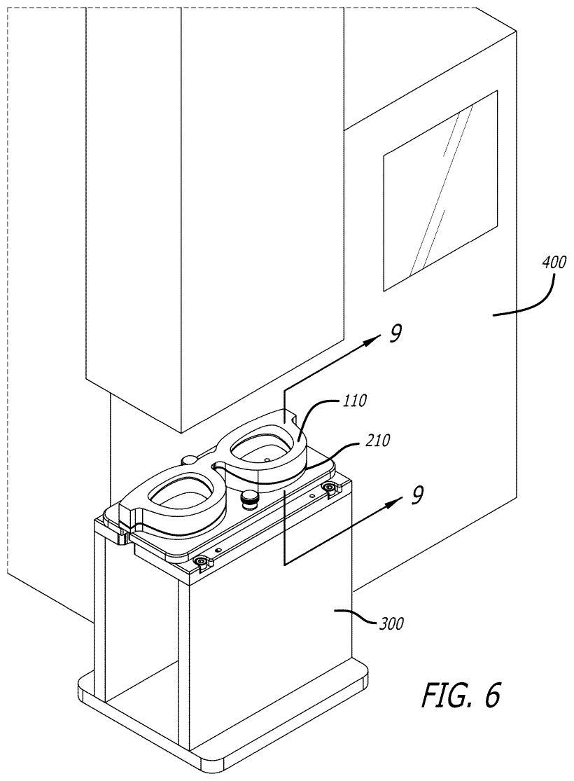

FIG. 6 shows the front piece 110 and the back piece 210 of the front frame of a pair of eyeglasses being welded using an ultrasonic welder 400. A so-called block weld may be applied which may simultaneously apply the desired parameters to the entirety of the article which is being welded. The front piece 110 and back piece 210 are designed in such a way that the only components physically touching one another are the mating lip 214 and the upper step 112 and lower step 114. The remainder of the back piece 210 and front piece 110 do not engage with one another. A weld can only occur with the components touching one another. So, the block welder can apply an ultrasonic pulse to the entirety of the combined article. Only the mating structures of both pieces 110, 210 will be joined.

Again, this aids in manufacturing, both in that the mating structures automatically will self-align through their overall design and, ultrasonic welding need not be particularly targeted at specific regions of the front and back pieces 110, 210, but need only be applied generally. Following this general application of ultrasonic pulse, the front and back pieces 110, 210 will be joined into a single piece. The thickness maintained in both pieces 110, 210 through manufacture thus far may be seen in FIG. 6, but once that the pieces are joined they will regain the traditional rigidity and durability of acetate one from another. So, these thick pieces may then be shaved down to a desired overall shape.

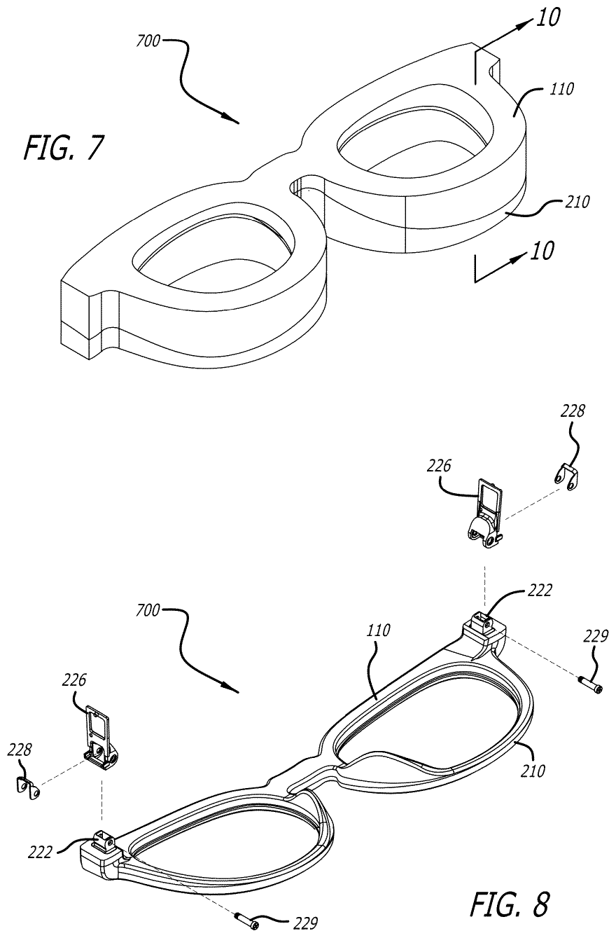

FIG. 7 shows the completed front frame 700 of a pair of eyeglasses, including excess material. The front frame 700 is made up of the back piece 210 and the front piece 110. The oversize nature of the front frame 700 may be seen in FIG. 7. It may now be milled down or otherwise finished into a smaller, more-traditional set of eyeglasses.

FIG. 8 shows the completed front frame 700 of a pair of eyeglasses, with excess material removed. The hinge studs 222 may now be seen. The hinge arms 226 may be added using the screws 229 and passed through the clip 228 on each side. Though shown here as being added to the front frame 700, the hinge arms 226 may be incorporated into one or more eyeglass arms before the screws 229 and clip 228 are added.

FIG. 9 shows an example cross-section of a mating lip 914 and a stepwise mating structure of two pieces of acetate prior to ultrasonic welding. As before the stepwise mating structure is made up of an upper step 922 and a lower step 924 which interact with the mating lip 914. The front piece 910 and back piece 920 are shown in cross section so that the welding process may be seen more clearly. Here, the mating lip 914 rests on the lower step 924 with the upper step 922 resting on the face of the front piece 910 adjacent to the hollow cavity 926. Prior to welding, the mating structure seems disjointed. But, the post-weld structure shown in FIG. 10 will reveal more detail.

FIG. 10 shows an example cross-section of a mating lip and a stepwise mating structure of two pieces of acetate following ultrasonic welding. Here the back piece 920 and the front piece 910 have been welded together through the application of ultrasonic welding. The preferred parameters are at a power of 5-6 kW with an amplitude of 30-35 microns at a frequency of 20 kHz for approximately one-half second. The combined front and back pieces 110, 210 are held as shown in FIG. 6. The ultrasonic welding process may not use precisely these parameters and may still function sufficiently-well to perform the welding. In such cases, the application of three to ten kilowatts of power at a frequency of five to forty kilohertz and an amplitude of ten to forty microns for between 0.1 and 1 second to perform the weld may be used.

Thereafter, the resulting weld has at least three faces. That is one of the benefits of the use of this particular mating structure, namely, that it increases the overall surface area of the join between the two pieces 910, 920 that are joined. One of the drawbacks of acetate welding in the past has been that insufficient material was joined and the weld would break down. With the increased surface area, surrounding the hollow cavity 926, it is as if the two pieces of acetate are a single piece. In addition, as mentioned above, the flow of melted acetate is “away” from the hollow cavity 926 and any sensitive electronics therein, toward the exterior of the combined pieces 910, 920. The stepwise structure in particular helps to ensure that melted acetate moves outward.

The resulting weld has at least three weld surfaces 1032, 1034, 1036. Two are horizontal (as shown here) relative to the face of the eyewear, and one is vertical (previously the step riser). A portion of the material shown in FIG. 9 comprising the lower step 924 has melted through the ultrasonic welding into the weld 1036. The increased surface area is available because there are different directions for those surfaces and lends further strength to the weld. The front piece 910 and back piece 920 are effectively joined into a single piece without seam. To the extent there is extruded material or extra material or gaps outside of the weld area, it may be milled away or polished away during a finishing process because, as discussed above, there is a great deal of excess material in both pieces 910, 920 at the ultrasonic welding phase.

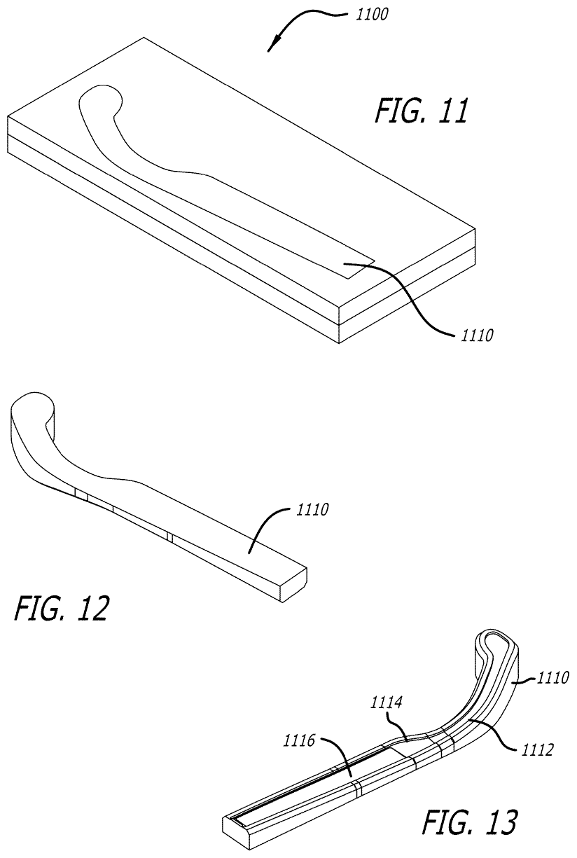

FIG. 11 shows an outer piece 1110 of a left earpiece of a pair of eyeglasses being cut from a block 1100 of acetate. As with the front and back pieces 110, 210 of the front piece of a pair of eyeglasses, a similar mating structure and overall process may be employed for the arms of the eyeglasses. Here, the outer piece 1110 of a left earpiece is being cut from the block 1100.

FIG. 12 shows an outer piece 1110 of a left earpiece of a pair of eyeglasses cut from a block of acetate. Here, the outer piece 1110 is shown separate from the block of acetate.

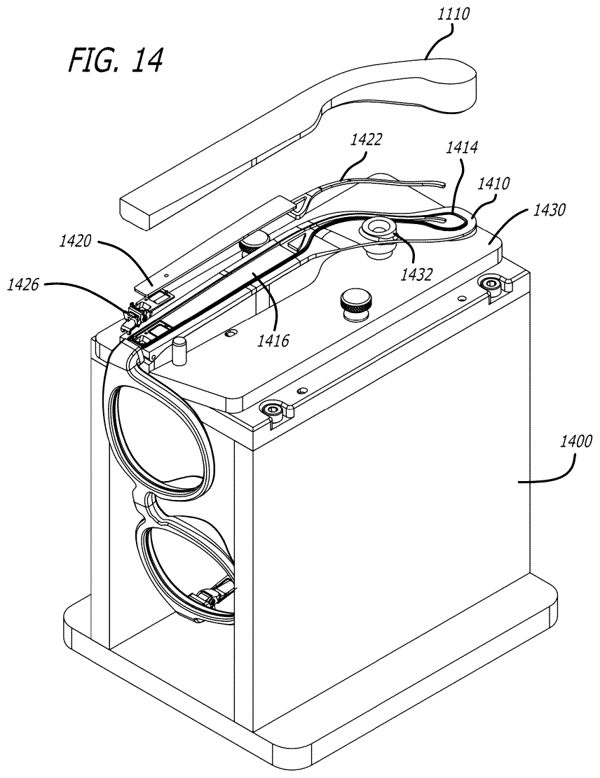

FIG. 13 shows the back of outer piece 1110 of a left earpiece of a pair of eyeglasses including a stepwise mating structure. The stepwise mating structure, much like the front piece 110 (FIG. 4) includes an upper step 1112 and a lower step 1114 around a hollow cavity 1116. The outer piece 1110 and inner piece FIG. 14) of the left earpiece may be joined in much the same way.

FIG. 14 shows an outer piece 1110 and inner piece 1410 of a left earpiece for a pair of eyeglasses cut from acetate being joined together with electronic components 1420 therein. Here the outer piece 1110 is being placed atop the inner piece 1410 which was also cut from a block of acetate to include the mating lip 1414. Reinforcing metal components 1422 may be inserted within the hollow cavity 1416 along with electronic components 1420. A hinge arm 1426 may be added at this stage within or as a part of the hollow cavity 1416 as well. A mount point 1432 for ensuring the inner piece 1410 remains in place during manufacture may be formed in the acetate of the inner piece 1410 when it is milled from an acetate block to aid in manufacturing. It may be removed during finishing, but during manufacturing, it serves to hold the inner piece 1410 in place on the manufacturing block 1430 and working stand 1400. Ultrasonic welding may be applied, much as in the same fashion as with the front and back pieces (FIG. 6). And, the excess material helps to ensure a “blocky” fit in the ultrasonic welder on the manufacturing block 1430 for the block weld to operate effectively.

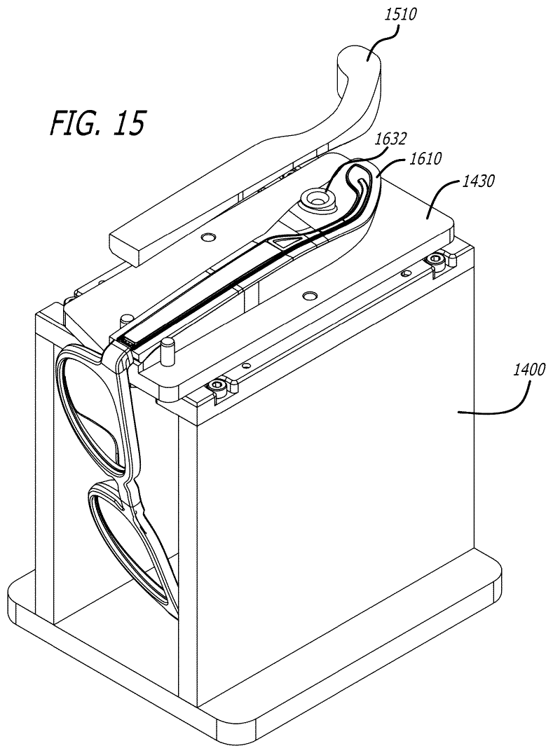

FIG. 15 shows an outer piece 1510 and inner piece 1610 of a right earpiece for a pair of eyeglasses cut from acetate being joined together with electronic components therein. The same manufacturing block 1430 and working stand 1400 may be used. And, a mount point 1632 may hold the inner piece 1610 in place during manufacture. The process is described sufficiently-well and mirrors that shown in FIG. 14, so it will not be reproduced here.

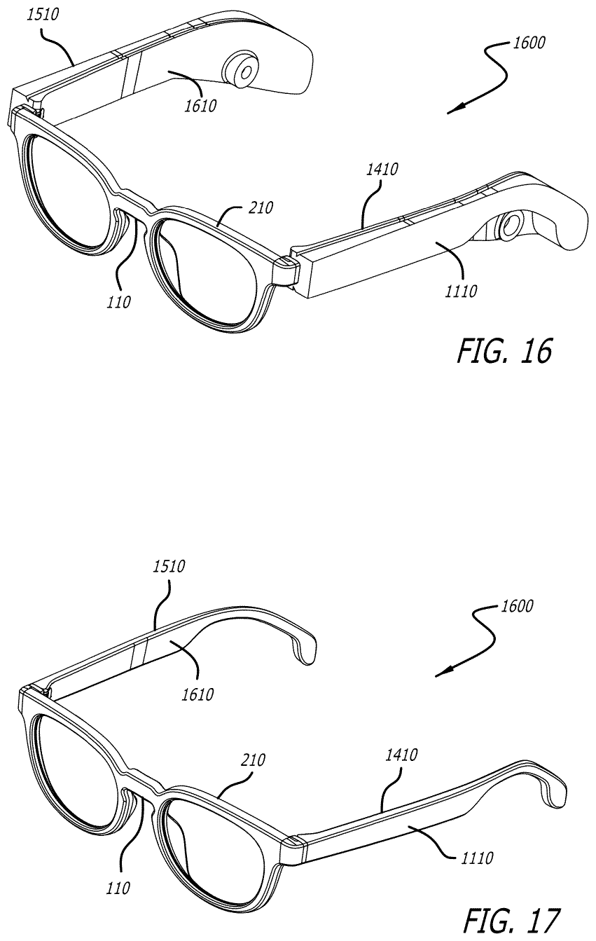

FIG. 16 shows a completed pair of eyeglasses 1600 including a left earpiece, a right earpiece, and a front frame having excess material on the left and right earpieces. The left earpiece is made up of inner piece 1410, and outer piece 1110, while the right earpiece is made up of inner piece 1610 and outer piece 1510. The front frame is made up of outer piece 110 and inner piece 210. There is a great deal of excess material on the left and right earpieces. That may be removed in finishing now that all of the components have been joined through ultrasonic welding. Though shown as excess material only on the earpieces, at this stage, all pieces may have excess material that is then removed through finishing, or only some portions may be, or polishing and final finishing may be applied after the pieces are joined together, but before the earpieces are added to the front frame.

FIG. 17 shows a completed pair of eyeglasses 1600 including a left earpiece, a right earpiece, and a front frame with all excess material removed. The front frame remains made up of a front piece 110 and a back piece 210. The left earpiece remains made up of the outer piece 1110 and the inner piece 1410, while the right earpiece remains made up of the inner piece 1610 and the outer piece 1510.

### Description of Processes

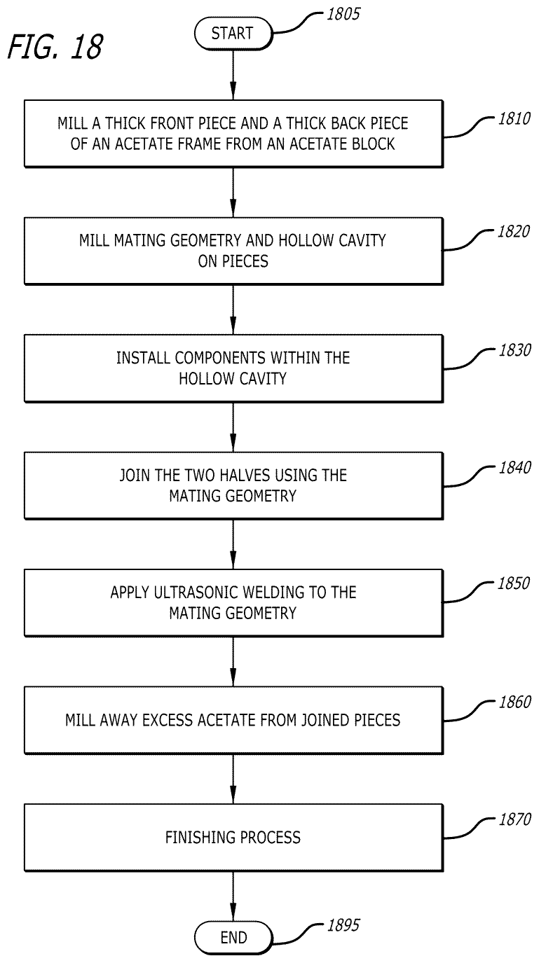

FIG. 18 is a flowchart of a process for creating an acetate enclosure for eyewear including electronic components. The process has a start 1805 and an end 1895, but may take place many times sequentially or simultaneously for the creation of acetate eyewear having a hollow cavity therewithin and including electronic components within the hollow cavity. The process is substantially discussed above with reference to FIGS. 1-17, but will be discussed herein specifically.

Following the start 1805, the process begins with milling out a thick front and a thick back piece of an acetate frame from an acetate block at 1810. This may be the front piece 110 and back piece 210 of FIGS. 1-4 or may be the inner and outer pieces of FIGS. 11-15. The pieces are intentionally thick and blocky to enable them to easily interface with the ultrasonic block welder.

As a part of the milling process of 1810 or as a separate process, the mating geometry and hollow cavity are milled into the pieces at 1820. Here, the mating lips, stepwise mating structure, and hollow cavity are milled into the respective pieces (e.g. one has the mating lips, the other has the stepwise mating structure, both have portions of the hollow cavity).

Next, components are installed within the hollow cavity at 1830. These components may be the hinge elements, reinforcing elements or nose pieces and the like, but they also may be or include the electronic components such as cameras, batteries, processors, memory, displays, LEDs or other lights, speakers, and transceivers (e.g. 802.11x wireless or Bluetooth® transceivers). These components are placed within the hollow cavity during assembly to enable them to be encased within the hollow cavity when the two pieces are joined together through the ultrasonic welding process.

Next, the two halves of the acetate are joined using the mating geometry at 1840. Here, the mating lip and the stepwise mating structure operate to self-align the two pieces of the eyewear as they are placed together. The pieces should naturally fit one within another, creating the hollow cavity. In this way, the pieces abut one another appropriately to be welded, while retaining the electronic components safe inside.

Next, ultrasonic welding is applied to the mating geometry at 1850. Preferably a block welder is used to apply ultrasonic welding uniformly, with uniform characteristics across the entirety of the mating structure. A spot welder or hand-held welder may also be used, but is not preferrable for mass manufacturing. The mating structure causes the mating lip and stepwise mating structure to weld together across three surfaces, thereby creating a single, acetate piece with the electronic components within the hollow cavity. The preferred parameters are at a power of 5-6 kW with an amplitude of 30-35 microns at a frequency of 20 kHz for approximately one-half second. The ultrasonic welding process may not use precisely these parameters and may still function sufficiently-well to perform the welding. In such cases, the application of three to ten kilowatts of power at a frequency of five to forty kilohertz and an amplitude of ten to forty microns for between 0.1 and 1 second to perform the weld may be used.

The inner and outer pieces (or front and back pieces) that have been joined together are then further milled down at 1860 into a desired shape. Because the pieces were initially thick to aid in retaining their strength and rigidity during manufacture and to prepare them for being joined together (e.g. uniformity of block ultrasonic welding across a thicker piece), then for them to become a final set of eyeglasses, they must be milled down to a desired shape. From a single, thick piece, many shapes may be possible or desirable. But, highly-precise milling using CNC or other machines is possible. And, excess ultrasonic weld overflow may likewise be milled and/or polished away.

Finally, finishing processes may be applied at 1870. Once a desired overall shape is reached at 1860, parts may be polished through blasting, tumbling or other processes well-known in the eyewear manufacturing industry.

Thereafter, the process ends at 1895.

### CLAUSES

### Clause 1

A method for manufacturing acetate eyewear comprising:
milling a first eyewear portion comprised of acetate to incorporate a mating lip, rectangular in cross-section having a first and a second side and a face, running a first near-perimeter of the first portion;
milling a second eyewear portion comprised of acetate to incorporate a counterpart stepwise mating structure, the counterpart stepwise mating structure having an upper step and a lower step, joined by a step riser, the lower step and the step riser having a second near-perimeter surrounding the first near-perimeter when the first eyewear portion and the second eyewear portion are mated together; and
wherein the second portion lower step matches the depth of the face of the mating lip and the step riser abuts the first face of the mating lip along one side of the near-perimeter when the first eyewear portion and the second eyewear portion are placed together.

### Clause 2

The method of clause 1 further comprising welding the at least one of the mating lip first lip and the face to at least one of the lower step and the step riser using ultrasonic welding to thereby join the first eyewear portion to the second eyewear portion.

### Clause 3

The method of clause 2 wherein the ultrasonic welding process uses five to six kilowatts of power at a frequency of twenty kilohertz and an amplitude of twenty to thirty microns for one-half second to perform the weld.

### Clause 4

The method of clause 2 wherein the ultrasonic welding process uses three to ten kilowatts of power at a frequency of five to forty kilohertz and an amplitude of ten to forty microns for between 0.1 and 1 second to perform the weld.

### Clause 5

The method of clause 1 wherein the first eyewear portion and the second eyewear portion are a front piece and a back piece of a front frame of the acetate eyewear, respectively.

### Clause 6

The method of clause 1 wherein the first eyewear portion and the second eyewear portion are an outside portion of an earpiece and an inside portion of an earpiece for the acetate eyewear, respectively.

### Clause 7

The method of clause 1 wherein a hollow body is formed between the first eyewear portion and the second eyewear portion having electronic components fixed therein

### Clause 8

The method of clause 1 further comprising the initial step of: milling each of the first eyewear portion and the second eyewear portion from a block of acetate material.

### Clause 9

The method of clause 2 further comprising:
milling a hollow cavity within at least one of the first eyewear portion and the second eyewear portion; and
placing at least one electronic component within at the hollow cavity prior to using ultrasonic welding to join the first eyewear portion to the second eyewear portion to thereby encapsulate the at least one electronic component therewithin the hollow cavity.

### Clause 10

A method of manufacturing acetate eyewear comprising:
creating a front portion of a front frame comprised of acetate, a back portion of the front frame comprised of acetate, a pair of exterior ear portions comprised of acetate, and a pair of interior ear portions comprised of acetate;
creating a first set selected from the group comprising the front portion and back portion, and a second set selected form the group comprising the pair of interior ear portions and the pair of exterior ear portions are milled to incorporate a mating lip, rectangular in cross-section having a first and a second side and a face, running a first near-perimeter of the first set and second set;
creating a third set selected as one not in the first set from the group comprising the front portion and back portion, and a fourth set selected as one not in the second set form the group comprising the pair of interior ear portions and the pair of exterior ear portions are milled to incorporate a counterpart stepwise mating structure, the counterpart stepwise mating structure having an upper step and a lower step, joined by a step riser, the lower step and the step riser having a second near-perimeter surrounding the first near-perimeter when the first set and the third set and the second set and the fourth set are mated together; and
wherein the third set and fourth set include a lower step matches the depth of the face of the mating lip in the first set and the second set and the step riser abuts the first face of the mating lip along one side of the near-perimeter when the first set and the second set are placed together with the third set and the fourth set.

### Clause 11

The method of clause 10 further wherein an ultrasonic welding process is used to cause the mating lip first lip and the face to weld to at least one of the lower step and the step riser to thereby join the first set and the second set to the third set and the fourth set, respectively.

### Clause 12

The method of clause 11 wherein the ultrasonic welding process uses five to six kilowatts of power at a frequency of twenty kilohertz and an amplitude of twenty to thirty microns for one-half second to perform the weld.

### Clause 13

The method of clause 11 wherein the ultrasonic welding process uses three to ten kilowatts of power at a frequency of five to forty kilohertz and an amplitude of ten to forty microns for between 0.1 and 1 second to perform the weld.

### Clause 14

The method of clause 10 further comprising hollow cavities formed between the first set and the second set mated to the third set and the fourth set, each of the hollow bodies having electronic components fixed therein.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. An acetate eyewear comprising:
a first portion comprised of acetate, the first portion milled to incorporate a mating lip, rectangular in cross-section having a first and a second side and a face, running a first near-perimeter of the first portion;
a second portion comprised of acetate, the second portion milled to incorporate a counterpart stepwise mating structure, the counterpart stepwise mating structure having an upper step and a lower step, joined by a step riser, the lower step and the step riser having a second near-perimeter surrounding the first near-perimeter when the first portion and the second portion are mated together; and
wherein the second portion lower step matches the depth of the face of the mating lip and the step riser abuts the first face of the mating lip along one side of the near-perimeter when the first portion and the second portion are placed together.

2. The acetate eyewear of claim 1 further wherein an ultrasonic welding process is used to cause at least one of the mating lip first lip and the face to weld to at least one of the lower step and the step riser to thereby join the first portion to the second portion.

3. The acetate eyewear of claim 2 wherein the ultrasonic welding process uses five to six kilowatts of power at a frequency of twenty kilohertz and an amplitude of twenty to thirty microns for one-half second to perform the weld.

4. The acetate eyewear of claim 2 wherein the ultrasonic welding process uses three to ten kilowatts of power at a frequency of five to forty kilohertz and an amplitude of ten to forty microns for between 0.1 and 1 second to perform the weld.

5. The acetate eyewear of claim 1 wherein the first portion and the second portion are a front piece and a back piece of a front frame of the acetate eyewear, respectively.

6. The acetate eyewear of claim 1 wherein the first portion and the second portion are an outside portion of an earpiece and an inside portion of an earpiece for the acetate eyewear, respectively.

7. The acetate eyewear of claim 1 further comprising a hollow body formed between the first portion and the second portion having electronic components fixed therein.

8. An acetate eyewear comprising:
a first portion of a front frame comprised of acetate, the first portion milled to incorporate a mating lip, rectangular in cross-section having a first and a second side and a face, running a first near-perimeter of the first portion;
a second portion of the front frame comprised of acetate, the second portion milled to incorporate a counterpart stepwise mating structure, the counterpart stepwise mating structure having an upper step and a lower step, joined by a step riser, the lower step and the step riser having a second near-perimeter surrounding the first near-perimeter when the first portion and the second portion are mated together; and
wherein the second portion lower step matches the depth of the face of the mating lip and the step riser abuts the first face of the mating lip along one side of the near-perimeter when the first portion and the second portion are placed together.

9. The acetate eyewear of claim 8 further wherein an ultrasonic welding process is used to cause the mating lip first lip and the face to weld to the lower step and the step riser to thereby join the first portion to the second portion.

10. The acetate eyewear of claim 9 wherein the ultrasonic welding process uses three to ten kilowatts of power at a frequency of five to forty kilohertz and an amplitude of ten to forty microns for between 0.1 and 1 second to perform the weld.

11. The acetate eyewear of claim 8 further comprising a pair of exterior arm portions and a pair of interior arm portions, the pair of exterior arm portions and the pair of interior arm portions likewise including counterpart mating lips along an interior near-perimeter of one of the pairs and counterpart step riser and counterpart lower step along an interior near-perimeter of the other of the pairs.

12. The acetate eyewear of claim 11 wherein the pair of exterior arm portions and the pair of interior arm portions are welded together using ultrasonic welding to join the mating lips and the counterpart step riser and the counterpart lower step.

13. The acetate eyewear of claim 12 further comprising two hollow cavities each formed between one of the pair of exterior arm portions and one of the pair of interior arm portions, each having electronic components fixed therein.

14. The acetate eyewear of claim 8 further comprising a hollow cavity formed between the first portion and the second portion having electronic components fixed therein.

15. An acetate eyewear comprising:
a front portion of a front frame comprised of acetate;
a back portion of the front frame comprised of acetate;
a pair of exterior ear portions comprised of acetate;
a pair of interior ear portions comprised of acetate;
wherein a first set selected from the group comprising the front portion and back portion, and a second set selected form the group comprising the pair of interior ear portions and the pair of exterior ear portions are milled to incorporate a mating lip, rectangular in cross-section having a first and a second side and a face, running a first near-perimeter of the first set and second set;
wherein a third set selected as one not in the first set from the group comprising the front portion and back portion, and a fourth set selected as one not in the second set form the group comprising the pair of interior ear portions and the pair of exterior ear portions are milled to incorporate a counterpart stepwise mating structure, the counterpart stepwise mating structure having an upper step and a lower step, joined by a step riser, the lower step and the step riser having a second near-perimeter surrounding the first near-perimeter when the first set and the third set and the second set and the fourth set are mated together; and
wherein the third set and fourth set include a lower step matches the depth of the face of the mating lip in the first set and the second set and the step riser abuts the first face of the mating lip along one side of the near-perimeter when the first set and the second set are placed together with the third set and the fourth set.

16. The acetate eyewear of claim 1 further wherein an ultrasonic welding process is used to cause the mating lip first lip and the face to weld to at least one of the lower step and the step riser to thereby join the first set and the second set to the third set and the fourth set, respectively.

17. The acetate eyewear of claim 2 wherein the ultrasonic welding process uses five to six kilowatts of power at a frequency of twenty kilohertz and an amplitude of twenty to thirty microns for one-half second to perform the weld.

18. The acetate eyewear of claim 2 wherein the ultrasonic welding process uses three to ten kilowatts of power at a frequency of five to forty kilohertz and an amplitude of ten to forty microns for between 0.1 and 1 second to perform the weld.

19. The acetate eyewear of claim 1 further comprising hollow cavities formed between the first set and the second set mated to the third set and the fourth set, each of the hollow bodies having electronic components fixed therein.
